(19) United States
(12) Patent Application Publication
(10) Pub. No.: US 2025/0013104 A1
(43) Pub. Date: Jan. 9, 2025

(54) LIGHT CONTROL FILM COMPRISING TRANSPARENT CONDUCTIVE LAYER, RESIN LAYER, AND TRANSPARENT PROTECTIVE BASE

(71) Applicant: NITTO DENKO CORPORATION, Osaka (JP)

(72) Inventor: Mariko Hirai, Ibaraki-shi (JP)

(73) Assignee: NITTO DENKO CORPORATION, Osaka (JP)

(21) Appl. No.: 18/889,964

(22) Filed: Sep. 19, 2024

Related U.S. Application Data
(63) Continuation of application No. 17/414,466, filed on Jun. 16, 2021.

(30) Foreign Application Priority Data
Dec. 17, 2018 (JP) 2018-235414

(51) Int. Cl. G02F 1/1339; G02F 1/1334

(52) U.S. Cl. CPC G02F 1/1339; G02F 1/1334; G02F 2202/28; G02F 2203/03

(57) ABSTRACT

Provided is a light control film that hardly causes damage to its functional layers (a light control layer and transparent conductive layers) while including thin base materials. The light control film of the present invention includes: a first transparent base material, a first transparent conductive layer, a light control layer, a second transparent conductive layer, and a second transparent base material in the stated order; and a first resin layer on a side of the first transparent conductive layer opposite to the light control layer, wherein the first resin layer has a modulus of elasticity at 23° C. of from 4.0×10⁴ Pa to 1.0×10⁵ Pa, and wherein the first transparent base material and the second transparent base material each have a thickness of 150 μm or less.

### TECHNICAL FIELD

The present invention relates to a light control film.

### BACKGROUND ART

Hitherto, there has been developed a light control film utilizing a light-scattering effect of a composite of a polymer and a liquid crystal material. Such light control film has a structure in which the liquid crystal material is phase-separated or dispersed in a polymer matrix, and hence allows a transmission mode for transmitting light and a scattering mode for scattering light to be controlled by matching refractive indices of the polymer and the liquid crystal material and applying a voltage to the composite to change alignment of the liquid crystal material. To achieve such driving, the light control film is typically formed by sandwiching a light control layer containing the composite between transparent conductive films. The transparent conductive films each typically include a base material and a transparent conductive layer formed on the base material.

The base materials to be introduced into the light control film together with the transparent conductive films have heretofore needed to have thicknesses enough to protect the functional layers (the light control layer and the transparent conductive layers). The light control film including the thick base materials tends to have a large winding diameter when wound in a roll shape, and hence it is difficult to produce the film in an elongated shape. Meanwhile, when the thicknesses of the base materials are reduced, there occurs a problem in that a load is applied to the functional layers by indentation, bending, or the like at the time of the production of the light control film and/or at the time of the application of the light control film, and hence the functional layers are liable to be damaged.

### CITATION LIST

### Patent Literature

[PTL 1] JP 2013-148687 A

### SUMMARY OF INVENTION

### Technical Problem

The present invention has been made to solve the problem, and an object of the present invention is to provide a light control film that hardly causes damage to its functional layers (a light control layer and transparent conductive layers) while including thin base materials.

### Solution to Problem

According to one embodiment of the present invention, there is provided a light control film, including: a first transparent base material, a first transparent conductive layer, a light control layer, a second transparent conductive layer, and a second transparent base material in the stated order; and a first resin layer on a side of the first transparent conductive layer opposite to the light control layer, wherein the first resin layer has a modulus of elasticity at 23° C. of from 4.0×10⁴ Pa to 5.0×10⁵ Pa, and wherein the first transparent base material and the second transparent base material each have a thickness of 150 μm or less.

In one embodiment, the light control film further includes a second resin layer on a side of the second transparent conductive layer opposite to the light control layer, wherein the second resin layer has a modulus of elasticity at 23° C. of from 4.0×10⁴ Pa to 5.0×10⁵ Pa.

In one embodiment, the first resin layer is arranged on a side of the first transparent base material opposite to the first transparent conductive layer.

In one embodiment, the second resin layer is arranged on a side of the second transparent base material opposite to the second transparent conductive layer.

In one embodiment, the light control film further includes a protective base material on a side of the first resin layer opposite to the first transparent base material.

In one embodiment, the first resin layer is a pressure-sensitive adhesive layer.

In one embodiment, the second resin layer is a pressure-sensitive adhesive layer.

In one embodiment, the first resin layer is arranged between the first transparent base material and the first transparent conductive layer.

In one embodiment, the second resin layer is arranged between the second transparent base material and the second transparent conductive layer.

### Advantageous Effects of Invention

According to the present invention, the light control film that hardly causes damage to its functional layers (a light control layer and transparent conductive layers) while including thin base materials can be provided by arranging the resin layers having specific moduli of elasticity. The light control film of the present invention whose base materials are reduced in thickness has a large windable amount in a predetermined weight, and hence can be produced in an elongated shape. In addition, the film includes the resin layer, and hence the functional layers are hardly damaged. Further, the light control film of the present invention has a light weight. The light control film in which the functional layers are effectively protected and which has a light weight is extremely advantageous in that the film is excellent in applicability.

### BRIEF DESCRIPTION OF DRAWINGS

FIG. 1 is a schematic sectional view of a light control film according to one embodiment of the present invention.

FIG. 2 is a schematic sectional view of a light control film according to another embodiment of the present invention.

FIG. 3 is a schematic sectional view of a light control film according to still another embodiment of the present invention.

### DESCRIPTION OF EMBODIMENTS

### A. Overall Configuration of Light Control Film

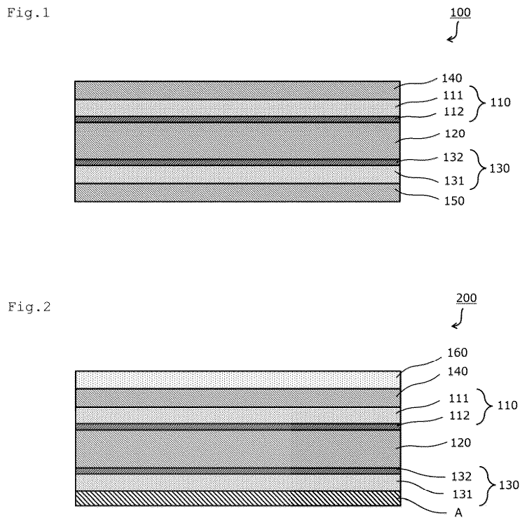

FIG. 1 is a schematic sectional view of a light control film according to one embodiment of the present invention. A light control film 100 includes a first transparent base material 111, a first transparent conductive layer 112, a light control layer 120, a second transparent conductive layer 132, and a second transparent base material 131 in the stated order, and includes a first resin layer 140 on the side of the first transparent conductive layer 112 opposite to the light control layer 120. The film preferably includes a second resin layer 150 on the side of the second transparent conductive layer 132 opposite to the light control layer 120. The first transparent base material 111 and the first transparent conductive layer 112 form a first transparent conductive film 110. In addition, the second transparent base material 131 and the second transparent conductive layer 132 form a second transparent conductive film 130. The first transparent conductive film and the second transparent conductive film are hereinafter sometimes collectively referred to as “transparent conductive films.” In addition, the first transparent base material and the second transparent base material are sometimes collectively referred to as “transparent base materials.” The first transparent conductive layer and the second transparent conductive layer are sometimes collectively referred to as “transparent conductive layers.”

The light control film formed by sandwiching the light control layer between the transparent conductive films is a film in which the light diffusibility of the light control layer can be controlled by the presence or absence of the application of a voltage. In one embodiment, the light control layer contains a liquid crystal compound. The light control layer containing the liquid crystal compound is formed by dispersing the liquid crystal compound in a resin matrix. In the light control layer, a transmission mode and a scattering mode can be switched by changing the degree of alignment of the liquid crystal compound on the basis of the presence or absence of the application of a voltage. In one embodiment, the light control layer is in the transmission mode under a state in which a voltage is applied thereto, and the light control layer is in the scattering mode under a state in which no voltage is applied thereto (normal mode). In this embodiment, at the time of the application of no voltage, the liquid crystal compound is not aligned, and hence the light control layer is brought into the scattering mode, and at the time of the application of a voltage, the liquid crystal compound is aligned, and hence the light control layer is brought into the transmission mode. In another embodiment, the light control layer is in the scattering mode under a state in which a voltage is applied thereto, and the light control layer is in the transmission mode under a state in which no voltage is applied thereto (reverse mode). In this embodiment, at the time of the application of no voltage, the liquid crystal compound is aligned, and hence the liquid crystal compound aligned state shows a refractive index substantially equal to that of the resin matrix. Thus, the light control layer is brought into the transmission mode. Meanwhile, the application of a voltage disturbs the alignment of the liquid crystal compound to bring the light control layer into the scattering mode.

In the embodiment illustrated in FIG. 1, the first resin layer 140 is arranged on the side of the first transparent base material 111 opposite to the first transparent conductive layer 112. In addition, the second resin layer 150 is arranged on the side of the second transparent base material 131 opposite to the second transparent conductive layer 132.

In one embodiment, the first resin layer 140 and/or the second resin layer 150 can function as a pressure-sensitive adhesive layer. When the first resin layer and/or the second resin layer functions as a pressure-sensitive adhesive layer, a separator (not shown) may be arranged outside the first resin layer and/or the second resin layer for the purpose of protecting its pressure-sensitive adhesive surface until the layer is put into use. The light control film illustrated in FIG. 1 may be used so that the light control film and an adherend (e.g., a glass for forming a shatterproof glass, or a window glass) may be bonded to each other via the first resin layer and the second resin layer each functioning as a pressure-sensitive adhesive layer.

FIG. 2 is a schematic sectional view of a light control film according to another embodiment of the present invention. A light control film 200 also includes the first transparent base material 111, the first transparent conductive layer 112, the light control layer 120, the second transparent conductive layer 132, and the second transparent base material 131 in the stated order, and includes the first resin layer 140 on the side of the first transparent conductive layer 112 opposite to the light control layer 120. More specifically, the film includes the first resin layer 140 on the side of the first transparent base material 111 opposite to the first light control layer 112.

The light control film 200 illustrated in FIG. 2 further includes a protective base material 160 on the side of the first resin layer 140 opposite to the first transparent base material 111. In this embodiment, the protective base material 160 laminated on the first transparent base material 111 via the first resin layer 140 can function as a protective film. On the second transparent base material 131 side, a resin layer and a protective base material may be arranged, or the resin layer and the protective base material may be not arranged. In one embodiment, as illustrated in FIG. 2, the first resin layer 140 and the protective base material 160 are arranged on the first transparent base material 111 side, and a pressure-sensitive adhesive layer A is arranged on the second transparent base material 131 side (i.e., the side of the second transparent base material opposite to the second transparent conductive layer). The light control film according to such embodiment may be used so that the light control film and an adherend (e.g., a window glass) may be bonded to each other via the pressure-sensitive adhesive layer A. In addition, after the bonding of the light control film, the protective film may be peeled together with the first resin layer as required. In addition, after the peeling of the protective film, a front surface plate, such as a glass plate or a resin plate, may be bonded to the first transparent base material side via any appropriate pressure-sensitive adhesive or adhesive. In the light control film, a separator (not shown) may be arranged outside the pressure-sensitive adhesive layer A for the purpose of protecting its pressure-sensitive adhesive surface until the layer is put into use.

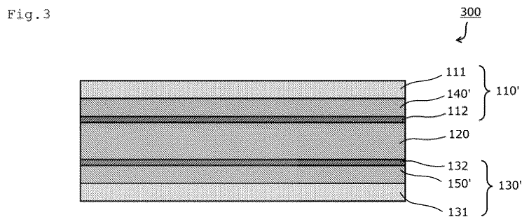

FIG. 3 is a schematic sectional view of a light control film according to still another embodiment of the present invention. A light control film 300 includes the first transparent base material 111, the first transparent conductive layer 112, the light control layer 120, the second transparent conductive layer 132, and the second transparent base material 131 in the stated order, and includes a first resin layer 140′ on the side of the first transparent conductive layer 112 opposite to the light control layer 120. The film preferably includes a second resin layer 150′ on the side of the second transparent conductive layer 132 opposite to the light control layer 120.

In the embodiment illustrated in FIG. 3, the first resin layer 140′ is arranged between the first transparent base material 111 and the first transparent conductive layer 112. In addition, the second resin layer 150′ is preferably arranged between the second transparent base material 131 and the second transparent conductive layer 132. In this embodiment, the first transparent base material 111, the first resin layer 140′, and the first transparent conductive layer 112 form a first transparent conductive film 110′. In addition, the second transparent base material 131, the second resin layer 150′, and the second transparent conductive layer 132 form a second transparent conductive film 130′. The light control film illustrated in FIG. 3 may be used so that the light control film and an adherend (e.g., a glass for forming a shatterproof glass, or a window glass) may be bonded to each other via any appropriate pressure-sensitive adhesive or adhesive.

The above-mentioned embodiments may be appropriately combined with each other, or the above-mentioned embodiments and a configuration that is well-known in the art may be combined with each other.

In one embodiment, the light control film of the present invention is provided in an elongated shape. The length of the light control film is, for example, 100 m or more, preferably from 500 m to 3,000 m.

In one embodiment, the light control film of the present invention is provided in a roll shape. For example, the light control film having the above-mentioned length may be provided under the state of being wound in a roll shape.

### B. First Resin Layer and Second Resin Layer

The modulus of elasticity of the first resin layer at 23° C. is from 4.0×10⁴ Pa to 5.0×10⁵ Pa. The modulus of elasticity of the second resin layer at 23° C. is preferably from 4.0×10⁴ Pa to 5.0×10⁵ Pa. In the present invention, when the resin layers having moduli of elasticity within the ranges are arranged, the resin layers can function as stress relaxation layers. Even when a force, such as bending or indentation, is applied to the light control film including such resin layers, its transparent conductive layers (the first transparent conductive layer and the second transparent conductive layer) and light control layer are hardly damaged. In the present invention, the transparent conductive layers and the light control layer are hardly damaged, and hence the thicknesses of the transparent base materials can be reduced. When the thicknesses of the transparent base materials are reduced, the windable amount of the film in a predetermined weight is large, and hence the film can be produced in an elongated shape. In addition, when the thicknesses of the transparent base materials are reduced, there can be obtained a light control film, which has a light weight and is excellent in applicability. That is, according to the present invention, there can be provided a lightweight light control film, which can be produced in an elongated shape and is prevented from causing damage to its transparent conductive layers and light control layer. Such light control film is useful in that the film is excellent in applicability. The first resin layer and the second resin layer are hereinafter sometimes collectively referred to as “resin layers.” The first resin layer and the second resin layer may have the same configuration, or may have different configurations. The term “modulus of elasticity” as used herein refers to a storage modulus of elasticity, and represents strain-holding energy with respect to a glass. When the modulus of elasticity of any one of the resin layers is small, the deformation amount thereof becomes large with respect to stress at the time of the bonding of the film, and hence damage to the light control layer may be large. Meanwhile, when the modulus of elasticity thereof is excessively large, the following risk occurs: the followability of the film to a bonding roll reduces at the time of its bonding; or warping becomes large at the time of the winding of an elongated roll, and hence it becomes difficult to wind the roll. A method of measuring the storage modulus of elasticity is described later.

The moduli of elasticity of the resin layers at 23° C. are preferably from 5.0×10⁴ Pa to 5.0×10⁵ Pa, more preferably from 5.0×10⁴ Pa to 4.0×10⁵ Pa. When the moduli of elasticity fall within such ranges, the effects of the present invention become significant.

The modulus of elasticity of the first resin layer at 23° C. is preferably lower than the modulus of elasticity of the first transparent base material of the first transparent conductive film at 23° C. The modulus of elasticity of the first resin layer at 23° C. is preferably 0.8 times or less, more preferably 0.6 times or less, still more preferably 0.4 times or less as high as the modulus of elasticity of the first transparent base material of the first transparent conductive film at 23° C. When the ratio of the former modulus of elasticity to the latter modulus of elasticity falls within such ranges, the effects of the present invention become significant.

The modulus of elasticity of the second resin layer at 23° C. is preferably lower than the modulus of elasticity of the second transparent base material of the second transparent conductive film at 23° C. The modulus of elasticity of the second resin layer at 23° C. is preferably 0.8 times or less, more preferably 0.6 times or less, still more preferably 0.4 times or less as high as the modulus of elasticity of the second transparent base material of the second transparent conductive film at 23° C. When the ratio of the former modulus of elasticity to the latter modulus of elasticity falls within such ranges, the effects of the present invention become significant.

The thicknesses of the resin layers are preferably from 10 μm to 100 μm, more preferably from 30 μm to 60 μm. When the thicknesses fall within such ranges, damage to the transparent conductive layers and the light control layer can be effectively prevented.

### (Resin Layers Functioning as Pressure-Sensitive Adhesive Layers)

As described above, in one embodiment, the resin layers can function as pressure-sensitive adhesive layers.

The moduli of elasticity of the resin layers functioning as pressure-sensitive adhesive layers at 23° C. are preferably from 4.0×10⁴ Pa to 1.0×10⁵ Pa, more preferably from 5.0×10⁴ Pa to 1.0×10⁵ Pa. When the moduli of elasticity fall within such ranges, damage to the transparent conductive layers and the light control layer can be effectively prevented.

The thicknesses of the resin layers functioning as pressure-sensitive adhesive layers are preferably from 10 μm to 100 μm, more preferably from 20 μm to 50 μm. When the thicknesses fall within such ranges, damage to the transparent conductive layers and the light control layer can be effectively prevented.

The resin layers functioning as pressure-sensitive adhesive layers are each formed of any appropriate pressure-sensitive adhesive. Examples of the pressure-sensitive adhesive include an acrylic pressure-sensitive adhesive, a silicone-based pressure-sensitive adhesive, a rubber-based pressure-sensitive adhesive, and an epoxy-based pressure-sensitive adhesive.

The silicone-based pressure-sensitive adhesive contains a silicone-based polymer as a base polymer. An example of the silicone-based polymer is a polymer including dimethylsiloxane as a constitutional unit. In addition, specific examples of the silicone-based pressure-sensitive adhesive include an addition reaction curable silicone-based pressure-sensitive adhesive and a peroxide curable silicone-based pressure-sensitive adhesive. A commercially available product may be used as the pressure-sensitive adhesive. Specific examples of the commercially available product include products manufactured by Dow Corning Toray Co., Ltd. (SD series), products manufactured by Shin-Etsu Silicones (KR-3700 series and X-40 series), and products manufactured by Shin-Etsu Chemical Co., Ltd. (K-100 series).

The acrylic pressure-sensitive adhesive contains an acrylic polymer as a base polymer. Examples of the acrylic polymer include: homopolymers or copolymers of alkyl (meth)acrylates (preferably C1 to C20 alkyl (meth)acrylates), such as methyl (meth)acrylate, ethyl (meth)acrylate, butyl (meth)acrylate, isoamyl (meth)acrylate, n-hexyl (meth)acrylate, 2-ethylhexyl (meth)acrylate, isooctyl (meth)acrylate, isononyl (meth)acrylate, decyl (meth)acrylate, and dodecyl (meth)acrylate; and a copolymer of any of the alkyl (meth)acrylates and any other copolymerizable monomer. Examples of the other copolymerizable monomer include: a carboxyl group- or acid anhydride group-containing monomer, such as acrylic acid, methacrylic acid, itaconic acid, fumaric acid, or maleic anhydride; a hydroxyl group-containing monomer, such as 2-hydroxyethyl (meth)acrylate; an amino group-containing monomer, such as morpholyl (meth)acrylate; and an amide group-containing monomer, such as (meth)acrylamide. The content ratio of a constitutional unit derived from the copolymerizable monomer is preferably 20 parts by weight or less, more preferably 15 parts by weight or less, still more preferably from 0.1 part by weight to 10 parts by weight with respect to 100 parts by weight of the base polymer.

The weight-average molecular weight of the acrylic polymer is preferably from 200,000 to 1,500,000, more preferably from 400,000 to 1,400,000. The weight-average molecular weight may be measured by GPC (solvent: THF).

The pressure-sensitive adhesive may further contain any appropriate additive as required. Examples of the additive include a cross-linking agent, a catalyst (for example, a platinum catalyst), a tackifier, a plasticizer, a pigment, a dye, a filler, an anti-aging agent, a conductive material, a UV absorber, a photostabilizer, a peeling modifier, a softener, a surfactant, a flame retardant, an antioxidant, and a solvent (e.g., toluene).

In one embodiment, the pressure-sensitive adhesive further contains a cross-linking agent. Examples of the cross-linking agent include an isocyanate-based cross-linking agent, an epoxy-based cross-linking agent, an aziridine-based cross-linking agent, and a chelate-based cross-linking agent. The content ratio of the cross-linking agent is preferably from 0.1 part by weight to 15 parts by weight, more preferably from 0.5 part by weight to 10 parts by weight with respect to 100 parts by weight of the base polymer contained in the pressure-sensitive adhesive. When the content ratio falls within such ranges, a pressure-sensitive adhesive tape that has an appropriate adhesive strength, is excellent in pressure-sensitive adhesive property for an uneven surface, and hardly causes adhesive residue when peeled off can be obtained.

### (Resin Layers for Forming Transparent Conductive Films)

As described above, in one embodiment, the resin layers are included in the first transparent conductive film and/or the second transparent conductive film (FIG. 3).

The moduli of elasticity of the resin layers for forming the transparent conductive films at 23° C. are preferably from 5.0×10⁴ Pa to 5.0×10⁵ Pa, more preferably from 1.0×10⁵ Pa to 4×10⁵ Pa. When the moduli of elasticity fall within such ranges, damage to the transparent conductive layers and the light control layer can be effectively prevented.

The thicknesses of the resin layers for forming the transparent conductive films are preferably from 5 μm to 50 μm, more preferably from 10 μm to 40 μm. When the thicknesses fall within such ranges, damage to the transparent conductive layers and the light control layer can be effectively prevented.

The densities of the resin layers for forming the transparent conductive films are preferably smaller than those of the base materials of the transparent conductive films. This is because a lightweight film can be obtained as compared to a case in which a base material film having the same thickness as the total thickness of the base material and the resin layer is used.

The resin layers for forming the transparent conductive films each preferably contain a curable resin. Examples of the curable resin for forming each of the resin layers include an acrylic resin, an epoxy-based resin, and a silicone-based resin.

The resin layers may each be formed by: applying a composition for forming a resin layer onto the corresponding transparent base material; and then curing the composition.

The composition for forming a resin layer preferably contains, as a curable compound serving as a main component, a polyfunctional monomer, an oligomer derived from a polyfunctional monomer, and/or a prepolymer derived from a polyfunctional monomer. Examples of the polyfunctional monomer include tricyclodecanedimethanol diacrylate, pentaerythritol di(meth)acrylate, pentaerythritol tri(meth)acrylate, trimethylolpropane triacrylate, pentaerythritol tetra(meth)acrylate, dimethylolpropane tetraacrylate, dipentaerythritol hexa(meth)acrylate, 1,6-hexanediol(meth)acrylate, 1,9-nonanediol diacrylate, 1,10-decanediol(meth)acrylate, polyethylene glycol di(meth)acrylate, polypropylene glycol di(meth)acrylate, dipropylene glycol diacrylate, isocyanuric acid tri(meth)acrylate, ethoxylated glycerin triacrylate, and ethoxylated pentaerythritol tetraacrylate. The polyfunctional monomers may be used alone or in combination thereof.

The content ratio of the polyfunctional monomer, the oligomer derived d from a polyfunctional monomer, and the prepolymer derived from a polyfunctional monomer is preferably from 30 parts by weight to 100 parts by weight, more preferably from 40 parts by weight to 95 parts by weight, particularly preferably from 50 parts by weight to 95 parts by weight with respect to 100 parts by weight of the total amount of the monomer, oligomer, and prepolymer in the composition for forming a resin layer. When the content ratio falls within such ranges, adhesiveness with each of the transparent conductive layers improves, and hence a conductive sheet that hardly causes interlayer peeling can be obtained. In addition, the shrinkage on curing of the resin layer can be effectively prevented.

The composition for forming a resin layer may contain a monofunctional monomer. When the composition for forming a resin layer contains the monofunctional monomer, the content ratio of the monofunctional monomer is preferably 40 parts by weight or less, more preferably 20 parts by weight or less with respect to 100 parts by weight of the total amount of the monomer, oligomer, and prepolymer in the composition for forming a resin layer.

Examples of the monofunctional monomer include ethoxylated o-phenylphenol (meth)acrylate, methoxy polyethylene glycol (meth)acrylate, phenoxy polyethylene glycol (meth)acrylate, 2-ethylhexyl acrylate, lauryl acrylate, isooctyl acrylate, isostearyl acrylate, cyclohexyl acrylate, isobornyl acrylate, benzyl acrylate, 2-hydroxy-3-phenoxy acrylate, acryloylmorpholine, 2-hydroxyethyl (meth)acrylate, 4-hydroxybutyl (meth)acrylate, and hydroxyethylacrylamide. In one embodiment, a monomer having a hydroxy group is used as the monofunctional monomer.

The composition for forming a resin layer may contain a urethane (meth)acrylate and/or an oligomer of the urethane (meth)acrylate. When the composition for forming a resin layer contains the urethane (meth)acrylate and/or the oligomer of the urethane (meth)acrylate, a resin layer excellent in flexibility can be formed. The urethane (meth)acrylate may be obtained by, for example, subjecting a hydroxy(meth)acrylate obtained from (meth)acrylic acid or a (meth)acrylate and a polyol to a reaction with a diisocyanate. The urethane (meth)acrylates and oligomers of the urethane (meth)acrylates may be used alone or in combination thereof.

Examples of the (meth)acrylate include methyl (meth)acrylate, ethyl (meth)acrylate, isopropyl (meth)acrylate, butyl (meth)acrylate, and cyclohexyl (meth)acrylate.

Examples of the polyol include ethylene glycol, 1,3-propylene glycol, 1,2-propylene glycol, diethylene glycol, dipropylene glycol, neopentyl glycol, 1,3-butanediol, 1,4-butanediol, 1,6-hexanediol, 1,9-nonanediol, 1,10-decanediol, 2,2,4-trimethyl-1,3-pentanediol, 3-methyl-1,5-pentanediol, neopentyl glycol hydroxypivalate, tricyclodecanedimethylol, 1,4-cyclohexanediol, spiroglycol, hydrogenated bisphenol A, a bisphenol A-ethylene oxide adduct, a bisphenol A-propylene oxide adduct, trimethylolethane, trimethylolpropane, glycerin, 3-methylpentane-1,3,5-triol, pentaerythritol, dipentaerythritol, tripentaerythritol, and glucoses.

For example, various kinds of aromatic, aliphatic, and alicyclic diisocyanates may each be used as the diisocyanate. Specific examples of the diisocyanate include tetramethylene diisocyanate, hexamethylene diisocyanate, isophorone diisocyanate, 2,4-tolylene diisocyanate, 4,4-diphenyl diisocyanate, 1,5-naphthalene diisocyanate, 3,3-dimethyl-4,4-diphenyl diisocyanate, xylene diisocyanate, trimethylhexamethylene diisocyanate, 4,4-diphenylmethane diisocyanate, and hydrogenated products thereof.

The total content ratio of the urethane (meth)acrylate and the oligomer of the urethane (meth)acrylate is preferably from 5 parts by weight to 70 parts by weight, more preferably from 5 parts by weight to 50 parts by weight with respect to 100 parts by weight of the total amount of the monomer, oligomer, and prepolymer in the composition for forming a resin layer. As long as the total content ratio falls within such ranges, a resin layer excellent in balance between hardness and flexibility can be formed.

The composition for forming a resin layer preferably contains any appropriate photopolymerization initiator.

The composition for forming a resin layer may or may not contain a solvent. Examples of the solvent include dibutyl ether, dimethoxymethane, methyl acetate, ethyl acetate, isobutyl acetate, methyl propionate, ethyl propionate, methanol, ethanol, and methyl isobutyl ketone (MIBK). Those solvents may be used alone or in combination thereof.

The composition for forming a resin layer may further contain any appropriate additive. Examples of the additive include a leveling agent, an antiblocking agent, a dispersion stabilizer, a thixotropic agent, an antioxidant, a UV absorber, an antifoaming agent, a thickener, a dispersant, a surfactant, a catalyst, a filler, a lubricant, and an antistatic agent.

As a method of applying the composition for forming a resin layer, any appropriate method may be adopted. Examples of the method include a bar coating method, a roll coating method, a gravure coating method, a rod coating method, a slot orifice coating method, a curtain coating method, a fountain coating method, and a comma coating method.

Any appropriate curing treatment may be adopted as a method of curing the composition for forming a resin layer. The curing treatment is typically performed by UV irradiation. The integrated light quantity of the UV irradiation is preferably from 200 mJ/cm² to 1,000 mJ/cm². Before the composition for forming a resin layer is cured, an applied layer formed of the composition for forming a resin layer may be heated. A heating temperature is preferably from 70° C. to 140° C., more preferably from 80° C. to 130° C.

### C. Transparent Conductive Films (First Transparent Conductive Film and Second Transparent Conductive Film)

In one embodiment, the transparent conductive films each include the transparent base material and the transparent conductive layer formed on the transparent base material (form illustrated in FIG. 1 or FIG. 2). In another embodiment, the transparent conductive films each include the transparent base material, the resin layer, and the transparent conductive layer in the stated order (form illustrated in FIG. 3). The resin layer is, for example, the resin layer described in the section B.

The thicknesses of the transparent conductive films are preferably from 50 μm to 200 μm, more preferably from 60 μm to 150 μm.

The surface resistance values of the transparent conductive films are preferably from 0.1Ω/□ to 1,000Ω/□, more preferably from 0.5Ω/□ to 300Ω/□, particularly preferably from 1Ω/□ to 200Ω/□.

The haze values of the transparent conductive films are preferably 20% or less, more preferably 10% or less, still more preferably from 0.1% to 5%.

The total light transmittances of the transparent conductive films are preferably 30% or more, more preferably 35% or more, particularly preferably 40% or more.

The transparent conductive layers may each be formed by using a metal oxide, such as indium tin oxide (ITO), zinc oxide (ZnO), or tin oxide (SnO₂). Alternatively, the transparent conductive layers may each be formed by using a metal nanowire, such as a silver nanowire (AgNW), a carbon nanotube (CNT), an organic conductive film, a metal layer, or a laminate thereof. The transparent conductive layers may each be patterned into a desired shape in accordance with purposes.

In one embodiment, the transparent conductive layers are directly formed on the transparent base materials, or when the transparent conductive films include the resin layers, the transparent conductive layers are directly formed on the resin layers. A specific example of this embodiment is a method including forming metal oxide layers on the transparent base materials or the resin layers on the basis of any appropriate film formation method (e.g., a vacuum deposition method, a sputtering method, a CVD method, an ion plating method, or a spray method) to provide the transparent conductive layers. The metal oxide layers may be used as they are as the transparent conductive layers, or may be further heated so that their metal oxides may be crystallized. A temperature at the time of the heating is, for example, from 120° C. to 200° C.

Any appropriate material may be used as a material for forming each of the transparent base materials. Specifically, a polymer base material, such as a film or a plastic base material, is preferably used. This is because the polymer base material is excellent in smoothness and wettability to a composition for forming a transparent conductive layer, and can significantly improve the productivity of the light control film through continuous production with a roll.

The material for forming each of the transparent base materials is typically a polymer film containing a thermoplastic resin as a main component. Examples of the thermoplastic resin include: a polyester-based resin; a cycloolefin-based resin, such as polynorbornene; an acrylic resin; a polycarbonate resin; and a cellulose-based resin. Of those, a polyester-based resin, a cycloolefin-based resin, or an acrylic resin is preferred. Those resins are each excellent in transparency, mechanical strength, thermal stability, moisture barrier property, and the like. The thermoplastic resins may be used alone or in combination thereof. In addition, such an optical film as used in a polarizing plate, such as a low-retardation base material, a high-retardation base material, a retardation plate, or a brightness enhancement film, may be used as each of the base materials.

The thicknesses of the transparent base materials are preferably 150 μm or less, more preferably from 5 μm to 100 μm, still more preferably from 5 μm to 70 μm, still more preferably from 10 μm to 50 μm. In the present invention, the thicknesses of the transparent base materials can be reduced as described above, and as a result, a light control film that can be produced in an elongated shape can be obtained.

The total light transmittances of the transparent base materials are preferably 30% or more, more preferably 35% or more, still more preferably 40% or more.

### D. Light Control Layer

As described above, in one embodiment, the light control layer contains the liquid crystal compound. Examples of the light control layer containing the liquid crystal compound include a light control layer containing a polymer-dispersed liquid crystal and a light control layer containing a polymer network-type liquid crystal. The polymer-dispersed liquid crystal has such a structure that the liquid crystal undergoes phase separation in a polymer. The polymer network-type liquid crystal has such a structure that the liquid crystal is dispersed in a polymer network, and the liquid crystal in the polymer network has a continuous phase.

Any appropriate liquid crystal compound of a non-polymeric type is used as the liquid crystal compound. Examples thereof include nematic, smectic, and cholesteric liquid crystal compounds. A nematic liquid crystal compound is preferably used because excellent transparency can be achieved in the transmission mode. Examples of the nematic liquid crystal compound include a biphenyl-based compound, a phenyl benzoate-based compound, a cyclohexylbenzene-based compound, an azoxybenzene-based compound, an azobenzene-based compound, an azomethine-based compound, a terphenyl-based compound, a biphenyl benzoate-based compound, a cyclohexylbiphenyl-based compound, a phenylpyridine-based compound, a cyclohexylpyrimidine-based compound, and a cholesterol-based compound.

The content of the liquid crystal compound in the light control layer is, for example, 40 wt % or more, preferably from 50 wt % to 99 wt %, more preferably from 50 wt % to 95 wt %.

A resin for forming the resin matrix of the light control layer may be appropriately selected depending on the light transmittance, the refractive index of the liquid crystal compound, and the like. The resin is typically an active energy ray-curable resin, and a liquid crystal polymer, a (meth)acrylic resin, a silicone-based resin, an epoxy-based resin, a fluorine-based resin, a polyester-based resin, and a polyimide resin may be preferably used.

The content of the resin matrix in the light control layer is preferably from 2 wt % to 60 wt %, more preferably from 5 wt % to 50 wt %. When the content of the resin matrix is less than 2 wt %, a problem of, for example, a reduction in adhesiveness with each of the substrates may occur. Meanwhile, when the content of the first polymer is more than 60 wt %, a problem of, for example, an increase in driving voltage or a reduction in light control function may occur.

The light control layer containing the liquid crystal compound may be formed by any appropriate method. The light control layer may be obtained by, for example, applying a composition for forming a light control layer to the first transparent conductive film to form an applied layer, laminating the second transparent conductive film on the applied layer to form a laminate “a”, and curing the applied layer. At this time, the composition for forming a light control layer contains, for example, a monomer (preferably, an active energy ray-curable monomer) for forming the resin matrix and the liquid crystal compound.

### E. Protective Base Material

Any appropriate material may be used as a material for forming the protective base material. Examples of the material for forming the protective base material include: cellulose-based resins, such as triacetyl cellulose (TAC); and polyester-based, polyvinyl alcohol-based, polycarbonate-based, polyamide-based, polyimide-based, polyethersulfone-based, polysulfone-based, polystyrene-based, polynorbornene-based, polyolefin-based, (meth)acrylic, and acetate-based transparent resins. In addition, examples thereof also include (meth)acrylic, urethane-based, (meth)acrylic urethane-based, epoxy-based, and silicone-based thermosetting resins or UV-curable resins.

The thickness of the protective base material is preferably from 20 μm to 100 μm, more preferably from 30 μm to 60 μm.

### F. Pressure-Sensitive Adhesive Layer a

The pressure-sensitive adhesive layer A is formed from any appropriate pressure-sensitive adhesive. In one embodiment, the pressure-sensitive adhesive contains a pressure-sensitive resin, and examples of the resin include a (meth)acrylic resin, an acrylic urethane-based resin, a urethane-based resin, a silicone-based resin, and an ethylene-vinyl acetate copolymer.

The pressure-sensitive adhesive may further contain any appropriate additive as required. Examples of the additive include a cross-linking agent, a tackifier, a plasticizer, a pigment, a dye, a filler, an age resistor, a conductive material, a UV absorber, a light stabilizer, a peeling modifier, a softener, a surfactant, a flame retardant, and an antioxidant. Examples of the cross-linking agent include an isocyanate-based cross-linking agent, an epoxy-based cross-linking agent, a peroxide-based cross-linking agent, a melamine-based cross-linking agent, a urea-based cross-linking agent, a metal alkoxide-based cross-linking agent, a metal chelate-based cross-linking agent, a metal salt-based cross-linking agent, a carbodiimide-based cross-linking agent, an oxazoline-based cross-linking agent, an aziridine-based cross-linking agent, and an amine-based cross-linking agent.

The thickness of the pressure-sensitive adhesive layer A is preferably from 3 μm to 100 μm, more preferably from 15 μm to 50 μm.

### EXAMPLES

Now, the present invention is specifically described by way of Examples, but the present invention is not limited to these Examples. Evaluation methods in Examples are as described below.

### (1) Modulus of Elasticity

A modulus of elasticity was determined with a dynamic viscoelasticity-measuring apparatus (manufactured by Rheometric Scientific, Inc., ARES) by the following method.

Only pressure-sensitive adhesive layers were removed from an evaluation laminate, and were laminated to have a thickness of about 2 mm. The laminate was punched into φ7.9 mm to produce a cylindrical pellet. Thus, a measurement sample was obtained. The measurement sample was fixed to the jigs of φ7.9 mm parallel plates, and its storage modulus of elasticity G′ was measured with the dynamic viscoelasticity-measuring apparatus. Conditions for the measurement are as described below.
Measurement: shear mode
Temperature range: from −70° C. to 150° C.
Temperature increase rate: 5° C./min
Frequency: 1 Hz

### (2) External Appearance

The external appearance of an evaluation laminate (glass/light control film/glass) obtained in each of Examples and Comparative Examples was visually observed.

### (3) Haze Value

The haze value (haze value in a scattering mode at the time of the application of no voltage) of a light control film and the haze value (haze value in the scattering mode at the time of the application of no voltage) of an evaluation laminate were measured, and the ratio at which the haze value of the evaluation laminate fluctuated with respect to the haze value of the light control film was determined. The haze values were measured in conformity with JIS 7136.

### (4) Weight Fluctuation

The total weight of glasses used in an evaluation laminate and the weight of the evaluation laminate were measured, and the ratio of the weight of the evaluation laminate to the total weight of the glasses used in the evaluation laminate was determined.

### Example 1

A first transparent conductive layer (ITO layer) was formed on a first transparent base material (PET base material, thickness: 50 μm) to provide a first transparent conductive film. In addition, a second transparent conductive layer (ITO layer) was formed on a second transparent base material (PET base material, thickness: 50 μm) to provide a second transparent conductive film.

A light control layer containing nematic liquid crystal molecules was sandwiched between those transparent conductive films so that the first transparent base material of the first transparent conductive film and the second transparent conductive layer of the second transparent conductive film were opposite to each other. Thus, a laminate A was formed.

A silicone-based pressure-sensitive adhesive was applied to each of both surfaces of the laminate A to form a pressure-sensitive adhesive layer (a first resin layer or a second resin layer) having a storage modulus of elasticity at 23° C. of 1.0×10⁵ Pa and a thickness of 50 μm. Thus, a light control film (first resin layer (pressure-sensitive adhesive layer)/first transparent base material/first transparent conductive layer/light control layer/second transparent conductive layer/second transparent base material/second resin layer (pressure-sensitive adhesive layer)) was obtained.

A glass plate was laminated on each of both surfaces of the light control film obtained as described above to provide an evaluation laminate. At the time of the lamination, a roller was reciprocated at a load of 2 kg once to bond the glass plate and the light control film to each other. The resultant evaluation laminate was subjected to the evaluations (2) to (4). The results are shown in Table 1.

### Example 2

A urethane-based double-sided pressure-sensitive adhesive sheet was bonded as a resin layer onto a transparent base material (PET base material, thickness: 50 μm), and a conductive layer (ITO layer) was further formed on the pressure-sensitive adhesive sheet to provide a transparent conductive film. The two transparent conductive films were prepared, and were defined as a first transparent conductive film and a second transparent conductive film.

A light control layer containing nematic liquid crystal molecules was sandwiched between those transparent conductive films so that the first transparent base material of the first transparent conductive film and the second transparent conductive layer of the second transparent conductive film were opposite to each other. Thus, a light control film (first transparent base material/first resin layer/first transparent conductive layer/light control layer/second transparent conductive layer/second resin layer/second transparent base material) was obtained.

A glass plate was laminated on each of both surfaces of the light control film via an ethylene-vinyl acetate copolymer-based pressure-sensitive adhesive to provide an evaluation laminate. At the time of the lamination, while heating was performed at 110° C., a roller was reciprocated at a load of 2 kg once to bond the glass plate and the light control film to each other. The resultant evaluation laminate was subjected to the evaluations (2) to (4). The results are shown in Table 1.

### Example 3

A laminate A (first transparent base material/first transparent conductive layer/light control layer/second transparent conductive layer/second transparent base material) was produced in the same manner as in Example 1.

A silicone-based pressure-sensitive adhesive was applied to the first transparent base material side of the laminate A to form a pressure-sensitive adhesive layer (first resin layer) having a storage modulus of elasticity at 23° C. of 1.0×10⁵ Pa and a thickness of 50 μm. A PET film serving as a protective base material was further laminated on the pressure-sensitive adhesive layer (first resin layer).

In addition, an optical acrylic pressure-sensitive adhesive (PRESSURE-SENSITIVE ADHESIVE No. 7 manufactured by Nitto Denko Corporation) was applied to the second transparent base material side of the laminate A to form a pressure-sensitive adhesive layer A. Thus, a light control film (protective base material/first resin layer (pressure-sensitive adhesive layer)/first transparent base material/first transparent conductive layer/light control layer/second transparent conductive layer/second transparent base material/pressure-sensitive adhesive layer A) was obtained.

A glass plate was laminated on the pressure-sensitive adhesive layer A of the light control film. At the time of the lamination, a roller was reciprocated at a load of 2 kg once to bond the glass plate and the light control film to each other.

Next, a laminate having the configuration “protective base material/first resin layer (pressure-sensitive adhesive layer)” was peeled from the light control film, and a glass plate was laminated on the first transparent base material via an ethylene-vinyl acetate copolymer-based pressure-sensitive adhesive to provide an evaluation laminate. At the time of the lamination, while heating was performed at 110° C., a roller was reciprocated at a load of 2 kg once to bond the glass plate and the light control film to each other. The resultant evaluation laminate was subjected to the evaluations (2) to (4). The results are shown in Table 1.

### Comparative Example 1

A light control film was produced in the same manner as in Example 1 except that the thickness of each of the first transparent base material and the second transparent base material was set to 188 μm. In addition, an evaluation laminate was formed in the same manner as in Example 1, and the evaluation laminate was subjected to the evaluations (2) to (4). The results are shown in Table 1.

### Comparative Example 2

A laminate A was produced in the same manner as in Example 1.

The laminate A was used as a light control film, and a glass plate was laminated on each of both surfaces of the laminate via a hot-melt type ethylene-vinyl acetate copolymer-based pressure-sensitive adhesive (thickness: 20 μm, modulus of elasticity: 5×10⁸ Pa), followed by press-bonding under heating at 100° C. and 0.05 MPa for 20 minutes. Thus, an evaluation laminate was obtained. The resultant evaluation laminate was subjected to the evaluations (2) to (4). The results are shown in Table 1.

TABLE 1

| | | | | Comparative | Comparative |
|---|---|---|---|---|---|
| | Example 1 | Example 2 | Example 3 | Example 1 | Example 2 |
| Thicknesses | 50 | 50 | 50 | 50 | 50 |
| of | | | | | |
| transparent | | | | | |
| base | | | | | |
| materials | | | | | |
| (μm) | | | | | |
| Configuration | First resin | First | Protective | First resin | First |
| of light | layer | transparent | base | layer | transparent |
| control | (pressure- | base | material/first | (pressure- | base |
| film | sensitive | material/first | resin layer | sensitive | material/ |
| | adhesive | resin | (pressure- | adhesive | first |
| | layer)/ | layer/first | sensitive | layer)/ | transparent |
| | first | transparent | adhesive | first | conductive |
| | transparent | conductive | layer)/first | transparent | layer/light |
| | base | layer/light | transparent | base | control |
| | material/ | control | base | material/ | layer/second |
| | first | layer/ | material/first | first | transparent |
| | transparent | second | transparent | transparent | conductive |
| | conductive | transparent | conductive | conductive | layer/ |
| | layer/light | conductive | layer/light | layer/light | second |
| | control | layer/second | control | control | transparent |
| | layer/ | resin | layer/second | layer/ | base |
| | second | layer/ | transparent | second | material |
| | transparent | second | conductive | transparent | |
| | conductive | transparent | layer/second | conductive | |
| | layer/ | base | transparent | layer/ | |
| | second | material | base | second | |
| | transparent | | material/pressure- | transparent | |
| | base | | sensitive | base | |
| | material/ | | adhesive layer | material/ | |
| | second resin | | A | second resin | |
| | layer | | | layer | |
| | (pressure- | | | (pressure- | |
| | sensitive | | | sensitive | |
| | adhesive | | | adhesive | |
| | layer) | | | layer) | |
| External | Satisfactory | Satisfactory | Satisfactory | Satisfactory | Unevenness |
| appearance | external | external | external | external | occurred in |
| | appearance | appearance | appearance | appearance | the light |
| | without any | without any | without any | without any | control |
| | unevenness | unevenness | unevenness | unevenness | layer. |
| Haze value | 0 | 0 | 0 | 0 | 1 |
| fluctuation | | | | | |
| (%) | | | | | |
| Weight | 2.7 | 2.7 | 2.7 | 11 | 2.7 |
| ratio | | | | | |
| (evaluation | | | | | |
| laminate/ | | | | | |
| glass) | | | | | |
| (%) | | | | | |

As is apparent from Table 1, the external appearance of the light control film of the present invention is maintained even when a load is applied thereto at the time of its application. Such result means that in the light control film of the present invention, the functional layers (the light control layer and the conductive layers) are not damaged. According to the present invention, there can be obtained the light control film that is prevented from causing damage to its functional layers while having a light weight.

### REFERENCE SIGNS LIST

100, 200, 300 light control film
110 first transparent conductive film
111 first transparent base material
112 first transparent conductive layer
120 light control layer
130 second transparent conductive film
131 second transparent base material
132 second transparent conductive layer
140 first resin layer
150 second resin layer

1. A light control film, comprising:
a first transparent base material, a first transparent conductive layer, a light control layer, a second transparent conductive layer, and a second transparent base material in the stated order; and
a first resin layer on a side of the first transparent conductive layer opposite to the light control layer,
wherein the first resin layer has a modulus of elasticity at 23° C. of from 4.0×10⁴ Pa to 5.0×10⁵ Pa,
the first transparent base material and the second transparent base material each have a thickness of 150 μm or less, and
the light control layer comprises a liquid crystal compound having an aligned state and a non-aligned state, wherein the aligned stated and the non-aligned state of the liquid crystal compound is switched in the presence or absence of an application of a voltage.

2. The light control film according to claim 1, further comprising a second resin layer on a side of the second transparent conductive layer opposite to the light control layer, wherein the second resin layer has a modulus of elasticity at 23° C. of from 4.0×10⁴ Pa to 5.0×10⁵ Pa.

3. The light control film according to claim 1, wherein the first resin layer is arranged on a side of the first transparent base material opposite to the first transparent conductive layer.

4. The light control film according to claim 2, wherein the second resin layer is arranged on a side of the second transparent base material opposite to the second transparent conductive layer.

5. The light control film according to claim 1, further comprising a protective base material on a side of the first resin layer opposite to the first transparent base material.

6. The light control film according to claim 1, wherein the first resin layer is a pressure-sensitive adhesive layer.

7. The light control film according to claim 2, wherein the second resin layer is a pressure-sensitive adhesive layer.

8. The light control film according to claim 1, wherein the first resin layer is arranged between the first transparent base material and the first transparent conductive layer.

9. The light control film according to claim 2, wherein the second resin layer is arranged between the second transparent base material and the second transparent conductive layer.
